(19) United States
(12) Patent Application Publication
(10) Pub. No.: US 2012/0180827 A1
(43) Pub. Date: Jul. 19, 2012

(54) CLEANING TOOL FOR REMOVAL OF CARBON DEPOSITS

(76) Inventor: DE-SING SONG, TAOYUAN COUNTY (TW)

(21) Appl. No.: 13/007,891

(22) Filed: Jan. 17, 2011

(51) Int. Cl. B08B 3/00

(52) U.S. Cl. 134/198

(57) ABSTRACT

A cleaning tool for removal of carbon deposits in combustion chamber of engines includes a tubular body having a first connection portion and a second connection portion on two ends thereof. The second connection portion is to be connected with the engine to be cleaned. A supply hose extends through the wall of the tubular body and an inlet end of the supply hose is located outside of the tubular body so that cleaning liquid is supplied from the inlet end and into the engine. A gap is defined between the inner periphery of the tubular body and the outer periphery of the supply hose. When the carbon deposits are dissolved, high pressurized is introduced into the engine via the cleaning liquid providing hose to suck the carbon deposits out from the engine via the gap and the first connection end of the tubular body.

### FIELD OF THE INVENTION

The present invention relates to a cleaning tool, and more particularly, to a cleaning tool for removal of carbon deposits in combustion chamber of engines.

### BACKGROUND OF THE INVENTION

A conventional gas internal combustion engine generally includes at least one spark plug for generating sparks which ignites the fuel in the combustion chamber of the engine so as to create power to drive the vehicle. During the process of combustion, some hydrocarbons and other ingredients in the fuel are not completely burned so that the carbon particles are combined with peroxides in the fuel to form the deposits which build up in the internal parts of the engine. The carbon deposits in the engine cause knocking and pining which make the performance of the engine worse and sometimes damage the engine.

The conventional way to clean up the carbon deposits is to pour cleaning liquid into the engine from the spark plug holes and the cleaning liquid dissolves the carbon deposits. High pressurized air is then introduced into the engine via the spark plug holes to blow the solved carbon deposits out from the engine. However, the conventional way will splash the mixture of the cleaning liquid and the carbon deposits and contaminates the parts near by. Furthermore, the cleaning liquid cannot be filled in the combustion chamber of the engine so that the result of the cleaning is not satisfied.

The present invention intends to provide a cleaning tool to clean the carbon deposits of the engine effectively and improve the shortcomings of the conventional cleaning method.

### SUMMARY OF THE INVENTION

The present invention relates to a cleaning tool and comprises a tubular body having a first connection portion and a second connection portion on two ends thereof. A supply hose extends through a wall of the tubular body and has an inlet end and an outlet end. The inlet end is located outside of the tubular body and the outlet end is located in the tubular body and close to the second connection portion of the tubular body. A gap is defined between the inner periphery of the tubular body and the outer periphery of the supply hose.

The primary object of the present invention is to provide a cleaning tool for removal of carbon deposits in combustion chamber of engines, wherein the cleaning liquid is supplied into the engine via the cleaning liquid providing hose, and a difference of pressure between the inside of the tubular body and the outer periphery of the supply hose sucks the dissolved carbon deposits out from the engine via the tubular body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the cleaning tool of the present invention;

FIG. 2 is a cross sectional view of the cleaning tool of the present invention;

FIG. 3 is a cross sectional view to show the second embodiment of the cleaning tool of the present invention;

FIG. 4 shows that the cleaning tool of the present invention is connected between the engine and the cleaning device having the suction hose and the connection hose;

FIG. 5 is an enlarged cross sectional view to show that the carbon deposits are sucked out via the tubular body of the cleaning tool of the present invention and the suction hose;

FIG. 6 is a perspective view to show the third embodiment of the cleaning-tool of the present invention, and

FIG. 7 is a perspective view to show the fourth embodiment of the cleaning tool of the present invention.

### DETAILED DESCRIPTION OF THE PREFERRED EMBODIMENT

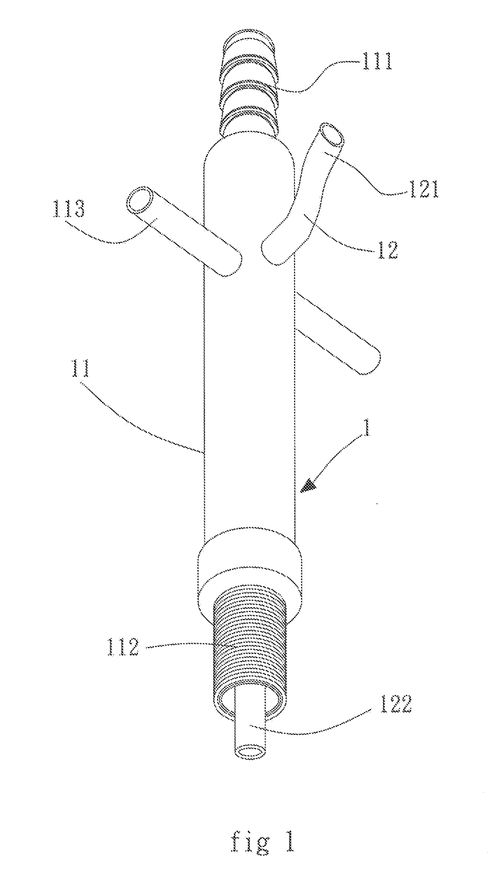

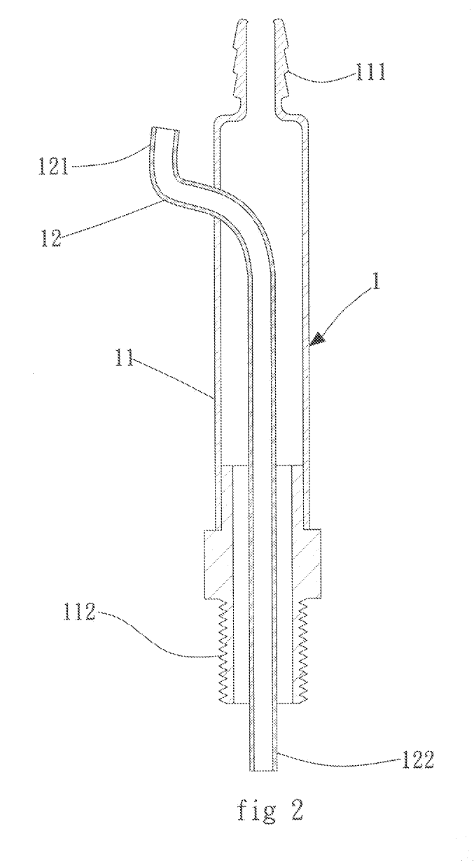

Referring to FIGS. 1 to 3, the cleaning tool 1 for removal of carbon deposits in combustion chamber of engines of the present invention comprises a tubular body 11 and a supply hose 12. The tubular body 11 includes a first connection portion 111 and a second connection portion 112 on two ends thereof. A handle 113 extends from the outer periphery of the tubular body 11 and is located close to the first connection portion 111 of the tubular body 11.

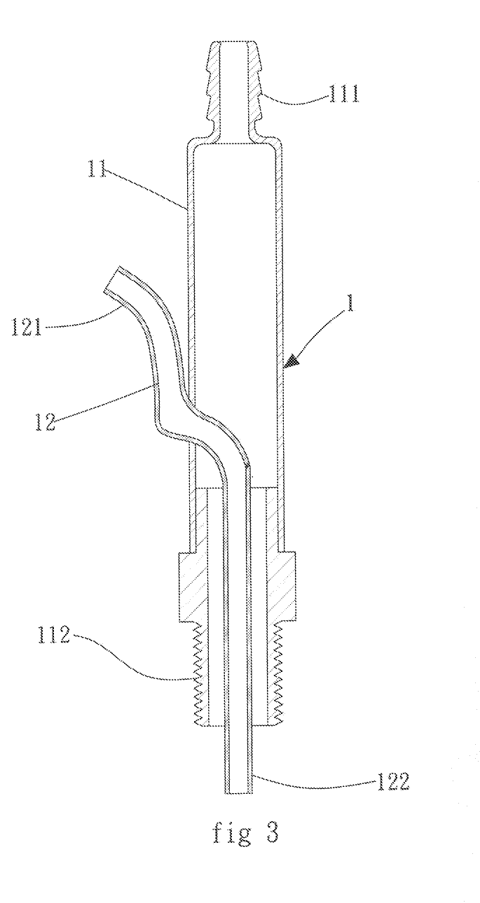

The supply hose 12 extends through the wall of the tubular body 11 and has an inlet end 121 and an outlet end 122, wherein the inlet end 121 located outside of the tubular body 11 and the outlet end 122 is located in the tubular body 11 and close to the second connection portion 112 of the tubular body 11. The inlet end 121 of the supply hose 12 is located close to the first connection portion 111 of the tubular body 11. A gap is defined between the inner periphery of the tubular body 11 and the outer periphery of the supply hose 12. It is noted that the inlet end 121 of the supply hose 12 can also be located close to the second connection portion 112 of the tubular body 11 as shown in FIG. 3.

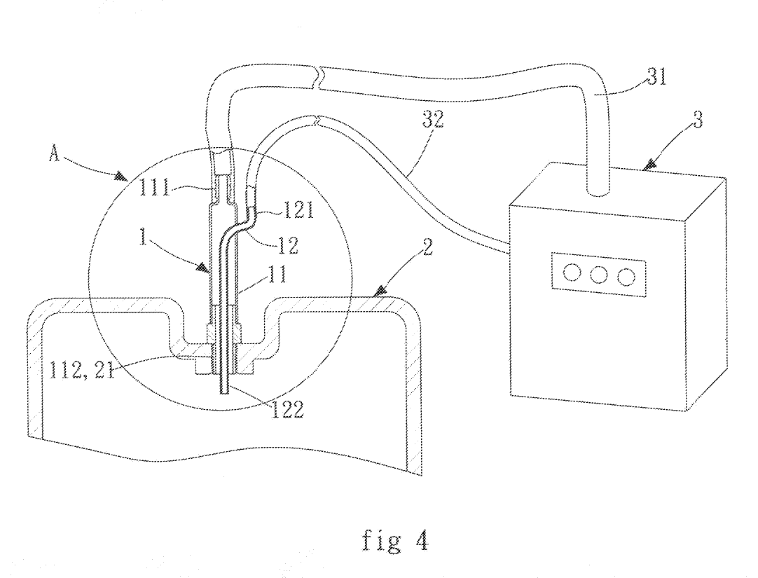

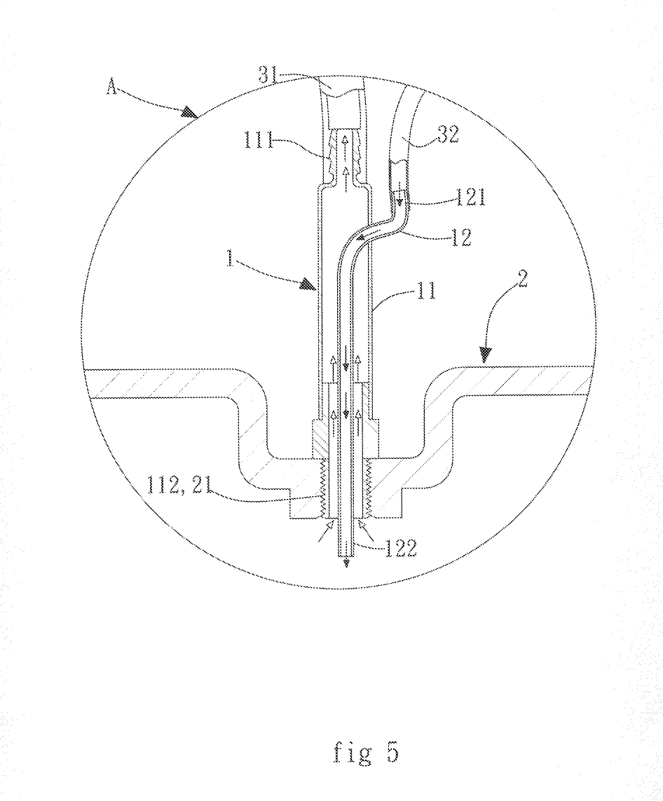

As shown in FIGS. 4 and 5, the second connection portion 112 of the tubular body 11 is threadedly connected to the spark plug hole 21 of the engine 2 by rotating the handle 113 on the tubular body 11 so that the outlet end 122 of the supply hose 12 is located in the combustion chamber of the engine 2. The suction hose 31 of the cleaning device 3 is then connected with the first connection portion 111 of the tubular body 11, and the cleaning liquid providing hose 32 of the cleaning device 3 is connected to the inlet end 121 of the supply hose 12. The cleaning liquid is then introduced into the combustion chamber of the engine 2 via the cleaning liquid providing hose 32 of the cleaning device 3 and the outlet end 122 of the supply hose 12. When the cleaning liquid dissolves the carbon deposits in the combustion chamber of the engine 2, high pressurized air is introduced into the combustion chamber of the engine 2 via the cleaning liquid providing hose 32. The difference of pressure between the inside of the tubular body 11 and the outer periphery of the supply hose 12 makes the dissolved carbon deposits be sucked out from the engine 2 via the tubular body 11 and the suction hose 31, and is collected in the cleaning device 3.

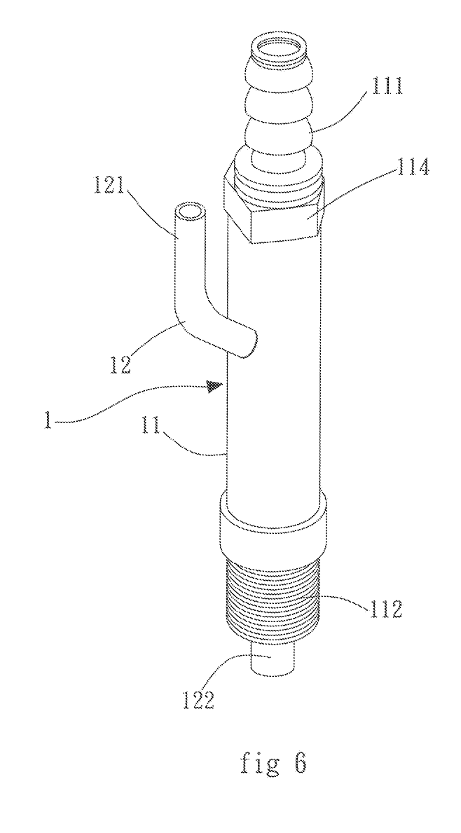

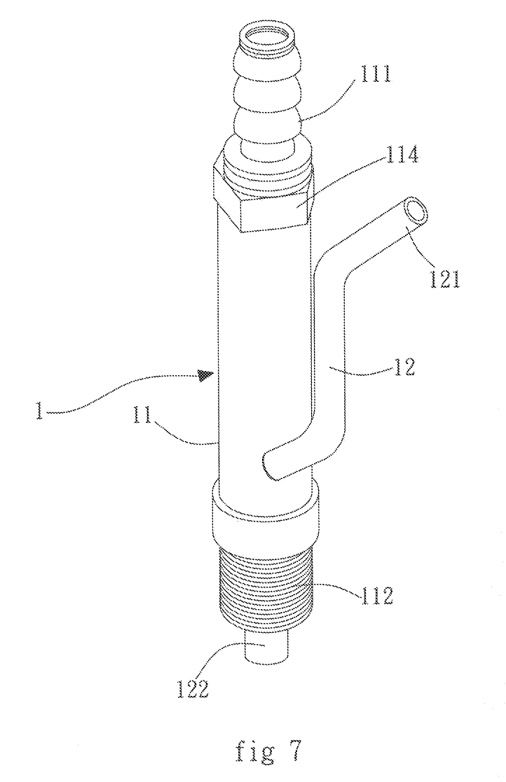

As shown in FIGS. 6 and 7, a polygonal section 114 is formed between the top end of the tubular body 11 and the bottom end of the first connection portion 111, such that when connecting the tubular body 11 to the engine 2, a tool is used to clamp the polygonal section 114 to rotate the tubular body 11 to complete the connection without the need of the handle 113. It is also noted that the supply hose 12 may eater through the wall of the tubular body 11 at position either close to first connection portion 111 or the second connection portion 112 of the tubular body 11.

The second connection portion 112 of the tubular body 11 is threadedly connected to the spark plug hole 21 of the engine 2, and there is a gap defined between the inner periphery of the tubular body 11 and the outer periphery of the supply hose 12, so that when the high pressurized air is introduced into the combustion chamber of the engine 2 via the cleaning liquid providing hose 32 and the outlet end 122 of the supply hose 12, the difference of pressure between the inside of the tubular body 11 and the outer periphery of the supply hose 12 makes the dissolved carbon deposits and the cleaning liquid be sucked out from the engine 2 via the tubular body 11 and the suction hose 31, and is collected in the cleaning device 3.

The combustion chamber of the engine 2 can be fully filled with the cleaning liquid so that the carbon deposits in the combustion chamber of the engine 2 can be fully dissolved. When the high pressurized air is introduced into the combustion chamber of the engine 2 via the cleaning liquid providing hose 32 and the outlet end 122 of the supply hose 12, the dissolved carbon deposits and the cleaning liquid are sucked out from the engine 2 via the tubular body 11 and the suction hose 31, and is collected in the cleaning device 3. The mixture of dissolved carbon deposits and the cleaning liquid does not splash from the spark plug hole 21 of the engine 2 to contaminate the parts around the engine 2. The mixture of dissolved carbon deposits and the cleaning liquid collected In the cleaning device 3 is convenient to be treated.

While we have shown and described the embodiment in accordance with the present invention, it should be clear to those skilled in the art that further embodiments may be made without departing from the scope of the present invention.

What is claimed is:

1. A cleaning tool comprising:
a tubular body having a first connection portion and a second connection portion on two ends thereof, and
a supply hose extending through a wall of the tubular body and having an inlet end and an outlet end, the inlet end located outside of the tubular body and the outlet end located in the tubular body and close to the second connection portion of the tubular body, a gap defined between an inner periphery of the tubular body and an outer periphery of the supply hose.

2. The cleaning tool as claimed in claim 1, wherein the inlet end is located close to the first connection portion of the tubular body.

3. The cleaning tool as claimed in claim 1, wherein the inlet end is located close to the second connection portion of the tubular body.

4. The cleaning tool as claimed in claim 1, wherein the tubular body includes a handle extending from an outer periphery thereof, the handle is located close to the first connection portion of the tubular body.

5. The cleaning tool as claimed in claim 1, wherein a polygonal section is formed between a top end of the tubular body and a bottom end of the first connection portion.
